(19) United States
(12) Patent Application Publication
(10) Pub. No.: US 2024/0007317 A1
(43) Pub. Date: Jan. 4, 2024

(54) VIRTUAL CONFERENCE MEETING SERVER CONTROLLING LINKED RELATIONSHIPS BETWEEN GROUPS OF COMMUNICATION SESSIONS

(71) Applicant: Telefonaktiebolaget LM Ericsson (publ), Stockholm (SE)

(72) Inventors: Jonas LUNDBERG, Luleå (SE); Gunilla BERNDTSSON, Nacka (SE); Xiaoping LI, Karlskrona (SE)

(21) Appl. No.: 18/037,391

(22) PCT Filed: Feb. 8, 2021
(86) PCT No.: PCT/EP2021/052927

§ 371 Date: May 17, 2023

(51) Int. Cl. H04L 12/18

(52) U.S. Cl. CPC H04L 12/1818; H04L 12/1822

(57) ABSTRACT

Virtual conference meeting server performing operations including scheduling a plurality of meetings responsive to input from a meeting organizer. The one of the plurality of meetings is a group meeting having an event time, a listing of permitted participants, and a group meeting identifier. The other one of the plurality of meetings is a subgroup meeting having a start time defined as a time offset to the event time of the group meeting, a subgroup listing of permitted participants, and a subgroup meeting identifier. The operations also include storing group meta data identifying the event time, the listing of permitted participants, and the group meeting identifier for the group meeting with a logical association to subgroup meta data identifying the time offset to the event time of the group meeting, the subgroup listing of permitted participants, and the subgroup meeting identifier for the subgroup meeting.

### TECHNICAL FIELD

The present disclosure relates to communications operational protocols for establishing, controlling, and terminating communication sessions between virtual conference meeting servers and client devices.

### BACKGROUND

Virtual conferencing technology has matured and is now easy to access which enables distributed teams to collaborate effortlessly. This has facilitated communication when workplaces are shifting to work from home. For the time being, existing solutions have been designed for stand-alone conferences, where the meeting organizer creates a meeting and invites a set of participants.

The Covid-19 pandemic has increased the need for working from home, creating a need for more advance virtual conference meeting arrangements, such as workshops, conferences and lectures with a large number of participants in different constellations. The participants may join a conference remotely using different meeting clients such as laptops, mobile phones, wearable devices such as smart watch, VR headset, AR headset, etc. or traditional voice call clients.

The rapidly increasing number of virtual conferences being scheduled among individuals within and between organizations and using a wide diversity of client devices has highlighted the need for significant improvements to the communications operational protocols used by virtual conference meeting servers to operate to schedule, establish, control, and terminate communication sessions between client devices and the virtual conference meeting servers.

### SUMMARY

Some embodiments disclosed herein are directed to a virtual conference meeting server. The virtual conference meeting server includes at least one processor and at least one memory storing program code executable by at least one processor to perform operations. The operations include scheduling a plurality of meetings responsive to input from a meeting organizer. The one of the plurality of meetings which is scheduled is a group meeting having an event time, a listing of permitted participants, and a group meeting identifier. The other one of the plurality of meetings which is scheduled is a subgroup meeting having a start time defined as a time offset to the event time of the group meeting, a subgroup listing of permitted participants, and a subgroup meeting identifier. The operations also include storing group meta data identifying the event time, the listing of permitted participants, and the group meeting identifier for the group meeting with a logical association to subgroup meta data identifying the time offset to the event time of the group meeting, the subgroup listing of permitted participants, and the subgroup meeting identifier for the subgroup meeting.

Numerous potential advantages can be provided by these and further operations of the virtual conference meeting server which are disclosed herein. By storing logical associations between the group meta data established for the group meeting and the subgroup meta data for one or more subgroup meetings, a meeting organizer can more operationally efficiently and reliably schedule, reschedule, and cancel hierarchically related meetings such as where some meeting participants are expected to move from a main group meeting to subgroup meetings and perhaps vice-versa. Moreover, as will be described in further detail herein, the operations by the virtual conference meeting server improve the operationally efficiency and reliability with how communication sessions are setup, controlled, and terminated between client devices and the server and with how media streams are combined and routed through the communication sessions.

In some further embodiments, the operations by the virtual conference meeting server further establish sessions with client devices of the permitted participants among the listing of permitted participants for the group meeting and the subgroup listing of permitted participants for the subgroup meeting. Responsive to occurrence of the event time, the operations combine media streams received in the sessions with the client devices of the permitted participants for the group meeting into combined group media streams and route the combined group media streams to the client devices of the permitted participants for the group meeting. Responsive to occurrence of the time offset to the start of the group meeting, the operations combine media streams received in the sessions with the client devices of the permitted participants for the subgroup meeting into combined subgroup media streams and route the combined subgroup media streams to the client devices of the permitted participants for the subgroup meeting.

In a further embodiment, the operations by the virtual conference meeting server respond to a request to move an identified participant from the subgroup meeting to the group meeting, by ceasing the combining of the media stream from the client device of the identified participant into the combined subgroup media streams, and initiating combining the media stream from the client device of the identified participant into the combined group media streams.

In another embodiment, the operations by the virtual conference meeting server respond to a request to create a breakout meeting having a listing of permitted breakout participants by, for any of the permitted breakout participants presently participating in the group meeting, ceasing the combining of the media stream from the client devices of any of the permitted breakout participants into the combined group media streams. The operations further respond by, for any of the permitted breakout participants presently participating in the subgroup meeting, ceasing the combining of the media stream from the client devices of any of the permitted breakout participants into the combined subgroup media streams. The operations further respond by initiating combining the media streams from the client devices of the permitted breakout participants into combined breakout media streams and routing the combined breakout media streams to the client devices of the permitted breakout participants.

Some other embodiments are directed to a method by a virtual conference meeting server for a plurality of meetings. The method includes scheduling the plurality of meetings responsive to input from a meeting organizer, where one of the plurality of meetings is a group meeting having an event time, a listing of permitted participants, and a group meeting identifier. Another one of the plurality of meetings is a subgroup meeting having a start time defined as a time offset to the event time of the group meeting, a subgroup listing of permitted participants, and a subgroup meeting identifier. The method further includes storing group meta data identifying the event time, the listing of permitted participants, and the group meeting identifier for the group meeting with a logical association to subgroup meta data identifying the time offset to the event time of the group meeting, the subgroup listing of permitted participants, and the subgroup meeting identifier for the subgroup meeting.

Other virtual conference meeting server and methods according to embodiments will be or become apparent to one with skill in the art upon review of the following drawings and detailed description. It is intended that all such virtual conference meeting server and methods be included within this description, be within the scope of the present disclosure, and be protected by the accompanying claims. Moreover, it is intended that all embodiments disclosed herein can be implemented separately or combined in any way and/or combination.

### BRIEF DESCRIPTION OF THE DRAWINGS

Aspects of the present disclosure are illustrated by way of example and are not limited by the accompanying drawings. In the drawings:

FIG. 1 illustrates a system having a virtual conference meeting server configured to control routing of media streams through communication sessions with participant client devices in accordance with some embodiments of the present disclosure;

FIG. 2 illustrates example operations for creating relationships between meetings and sharing properties and data in accordance with some embodiments of the present disclosure;

FIG. 3 illustrates a logical operational view of the database where relationships between one main group and two subgroup meetings have been created and followed by a personalized view for a user invited to group meeting 2 in accordance with some embodiments of the present disclosure;

FIG. 4 illustrates a logical operational view of the database where three concurrent demo sessions are running, and every 20 minutes each demo is restarted with a new group of participants, and for each participant the schedule is automatically created to ensure the groups stay small, in accordance with some embodiments of the present disclosure;

FIG. 5 illustrates a logical operational view of the database where a track from a multi-track conference is shown, and the corresponding view for an invited user in accordance with some embodiments of the present disclosure;

FIG. 6 illustrates components that may be included in the virtual conference meeting server of FIG. 1 which are configured to operation in accordance with some embodiments of the present disclosure; and

FIGS. 7 through 18 illustrates flowcharts of operations performed by a virtual conference meeting server in accordance with some embodiments of the present disclosure.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of various present inventive concepts to those skilled in the art. It should also be noted that these embodiments are not mutually exclusive. Components from one embodiment may be tacitly assumed to be present/used in another embodiment.

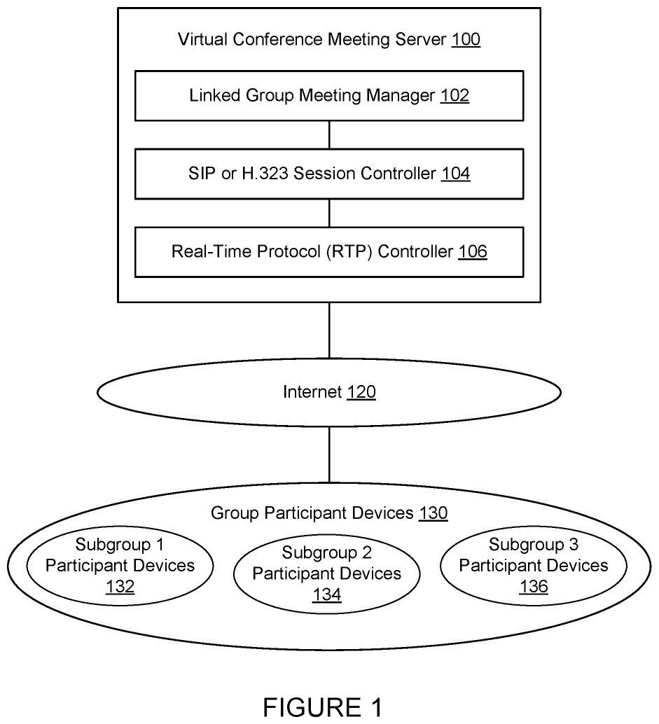

FIG. 1 illustrates a system having a virtual conference meeting server 100 which is configured to enable scheduling a group meetings and subgroup meetings that are logically associated to the group meetings. A meeting organizer can logically associate group and subgroup meetings so that the collection of logically associated meetings can be more operationally efficiently and reliably managed and changed. The virtual conference meeting server 100 includes a linked group meeting manager 102, a session controller 104 which may operate with Session Initiation Protocol (SIP) and/or H.323 protocol, and a real-time protocol (RTP) controller 106. The linked group meeting manager 102 enables a meeting organizer to define logically associated meetings, such as a main meeting and associated subgroup meetings and to define what participants are permitted in each of the meetings and how the timing of the meetings are logically interrelated. The linked group meeting manager 102 can operationally efficiently and reliably schedule, reschedule, and cancel interrelated meetings without requiring the meeting organizer to separately and manually perform those operations for each of the interrelated meetings. The linked group meeting manager 102 can provide meeting participants with a personal calendar-view that indicates what collection of interrelated meetings they are permitted to join and the interrelated timing of the meetings.

Numerous potential advantages can be provided by these and further operations of the virtual conference meeting server which are disclosed herein. By storing logical associations between the group meta data established for the group meeting and the subgroup meta data for one or more subgroup meetings, a meeting organizer can more operationally efficiently and reliably schedule, reschedule, and cancel hierarchically related meetings such as where some meeting participants are expected to move from a main group meeting to subgroup meetings and perhaps vice-versa. Moreover, as will be described in further detail herein, the operations by the virtual conference meeting server improve the operationally efficiency and reliability with how communication sessions are setup, controlled, and terminated between client devices and the server and with how media streams are combined and routed through the communication sessions. The advantages of these operations can become particularly important when group and subgroup meetings involve many participants and/or when the meeting are scheduled to occur with repetitiveness.

The session controller 104 can operate under control of the linked group meeting manager 102 to setup, control, and terminate communication sessions between the virtual conference meeting server 100 and the group participant devices 130 pursuant to metadata established for the scheduled interrelated meetings. As will be explained in further detail below, the session controller 104 may use, for example, SIP and/or H.323 protocol to manage the communication sessions. Moreover as we explained in further detail below, the session controller 104 under control of the linked group meeting manager 102 can select which media streams from which of the communication sessions among the group adjustment devices 130 are combined and then routed to which of the group participant devices 130 in order to provide virtual conference services for each of the presently ongoing interrelated meetings.

In the example of FIG. 1, the virtual conference meeting server 100 communicates with group participant devices 130 through the Internet 120 but may additionally or alternatively communicate via a private network. The group adjustment devices 130 are illustrated as being operationally organized by the linked group meeting manager 102 into subgroup_1 participant devices 132, subgroup_2 participant devices 134, and subgroup_3 participant devices 136 which correspond to three subgroup meetings that are simultaneously being conducted in which are logically associated with a main group meeting. The participant devices, also referred to as client devices, run client programs which communicate with the virtual conference meeting server 100 via respective communication sessions to provide the virtual conference meeting services to participants. The participant devices 130 (also referred to as client devices) can be any type of electronic communication device which can include, without limitation, a laptop computer, table computer, mobile phone, gaming console, etc. or a gateway that is configured to establish dial-in connections via traditional voice calls.

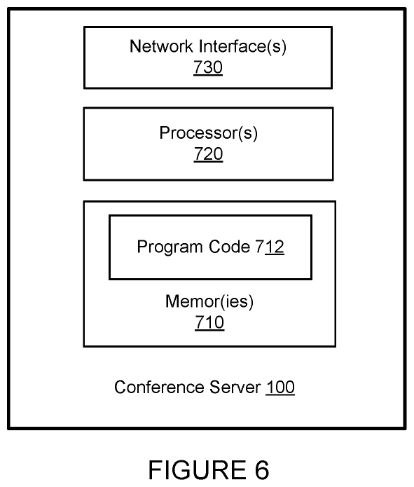

FIG. 6 illustrates hardware circuit components that may be included in the virtual conference meeting server of FIG. 1 which are configured to operation in accordance with some embodiments of the present disclosure. Referring to FIG. 6, the virtual conference meeting server 100 can include at least one network interface 730 (processor for brevity), at least one processor 720 (processor for brevity), and at least one memory 710 (processor for brevity) storing program code 712. The processor 720 may include one or more data processing circuits, such as a general purpose and/or special purpose processor (e.g., microprocessor and/or digital signal processor) that may be collocated or distributed across one or more networks. The processor 720 is configured to execute the program code 712 to perform operations according to one or more embodiments disclosed herein for a virtual conference meeting server.

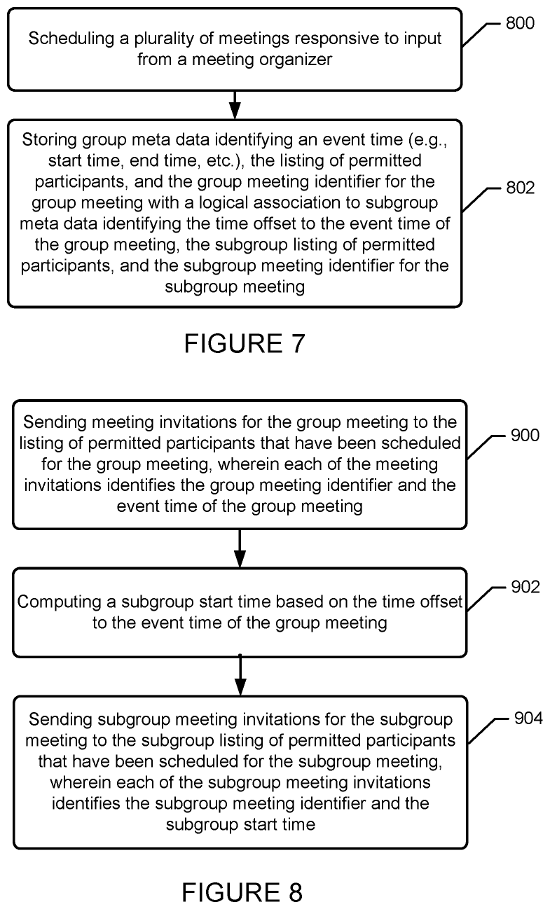

FIG. 7 illustrates a flowchart of operations by the virtual conference meeting server 100 in accordance with some embodiments of the present disclosure.

Referring to FIG. 7, the operations by the virtual conference meeting server 100 include scheduling 800 a plurality of meetings responsive to input from a meeting organizer. One of the plurality of meetings is a group meeting having an event time, a listing of permitted participants, and a group meeting identifier which are scheduled. A user can define the event time to correspond to a start time of the group meeting, an end time of the group meeting, the start of a presentation by a presenter in the group meeting, or another defined time event of the group meeting. Another one of the plurality of meetings is a subgroup meeting having a start time defined as a time offset to the event time of the group meeting, a subgroup listing of permitted participants, and a subgroup meeting identifier which are scheduled. The operations also include storing 802 group meta data identifying the event time, the listing of permitted participants, and the group meeting identifier for the group meeting with a logical association to subgroup meta data identifying the time offset to the event time of the group meeting, the subgroup listing of permitted participants, and the subgroup meeting identifier for the subgroup meeting.

FIG. 8 illustrates a flowchart of further operations by the virtual conference meeting server 100 in accordance with some embodiments of the present disclosure.

In some embodiments, the start time of the subgroup meeting can be automatically adjusted based on a change to the event time of the group meeting or the start time of the subgroup meeting may be manually adjusted. For example, when a group meeting is scheduled to run from 11 AM to 12 AM and an associated subgroup meeting is scheduled to run from 1:30 PM to 2:30 PM, responsive to the group meeting overrunning its end time the virtual conference meeting server 100 may generate a notification to the meeting organizer requesting a new start time for the subgroup meeting (and may provide a proposed new start time to the meeting organizer) and/or may automatically recompute a new start time for the subgroup meeting. The new start time for the subgroup meeting can be sent as notifications to the subgroup meeting participants.

Referring to FIG. 8, the operations further include sending 900 meeting invitations for the group meeting to the listing of permitted participants that have been scheduled for the group meeting, where each of the meeting invitations identifies the group meeting identifier and the event time of the group meeting. The operations also include computing 902 a subgroup start time based on the time offset to the event time of the group meeting. The operations also include sending 904 subgroup meeting invitations for the subgroup meeting to the subgroup listing of permitted participants that have been scheduled for the subgroup meeting, where each of the subgroup meeting invitations identifies the subgroup meeting identifier and the subgroup start time.

An example implementation of some of these embodiments will now be explained for completeness and without limitation on the possible scope of operation of a virtual conference meeting server in accordance with the present disclosure.

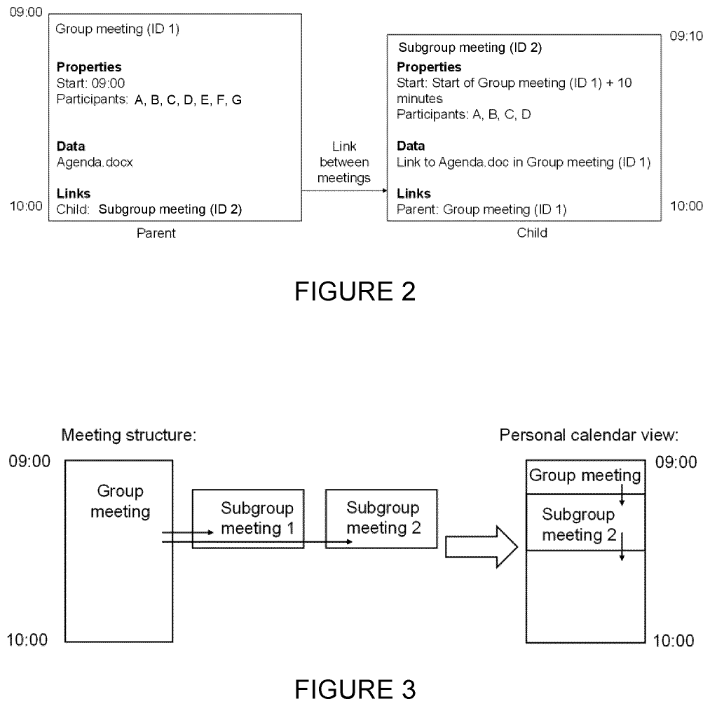

FIG. 2 illustrates example operations for creating relationships between meetings and sharing properties and data in accordance with some embodiments of the present disclosure. A meeting organizer schedules in a database, via the virtual conference meeting server 100, a group meeting (ID1) having a start time of 09:00 and an end time of 10:00, and invites a set of participants (A, B, C, D, E, F, G) who are also referred to as group meeting participants. The meeting organizer also schedules a subgroup meeting (ID2), via the virtual conference meeting server 100, with a start time defined as 10 minutes after the start time of the group meeting (ID1) and invites a set of participants (A, B, C, D) who are also referred to as subgroup participants. At 9:10, the virtual conference meeting server 100 invites the subgroup participants A, B, C, D to leave the group meeting (ID1) and join the subgroup meeting (ID2).

The meeting organizer logically associates (links) the group meeting to the subgroup meeting. These meetings may be linked with a parent/child relation, and properties can be shared, such as by the operations shown in FIG. 2 and FIG. 3.

The meeting organizer establishes a relative timing relationship making parameters of the subgroup meeting (child), such as the subgroup meeting's start time, dependent on a defined time event for the group meeting (parent). As explained above, the defined time event for the group meeting may correspond to a start time of the group meeting, an end time of the group meeting, the start of a presentation by a presenter in the group meeting, or another defined time event of the group meeting. There can be multiple subgroup meetings (child meetings) logically associated with a single group meeting (parent). Which of the various meetings becomes the group meeting (parent) and which other meetings become the subgroup meetings (children) can be determined based on the order at which the various meeting were created and/or based on their respective start times, end times, etc. as illustrated in FIG. 2. Alternatively or additionally, the decision as to which meeting is the group meeting and which is the subgroup meeting(s) may be based on which meeting has the most participants, such as illustrated in FIG. 3.

FIG. 3 illustrates a logical operational view of the database where relationships between one main group and two subgroup meetings have been created and followed by a personalized view for a user invited to group meeting 2 in accordance with some embodiments of the present disclosure. More particularly, the group meeting participants are moved to a plurality of subgroup meetings, i.e., subgroup meeting 1 and subgroup meeting 2. A person who is invited to subgroup meeting 2 can have a calendar invitation for the subgroup meeting 2 added to that person's calendar view. The start time for the subgroup meeting 2 can be defined as an offset time from an event time defined for the group meeting, such as explained above.

The logical association can be used to move the appropriate participants from the group meeting to a subgroup meeting and/or from a subgroup meeting to the group meeting, which means all the meetings should store location association information as meta data.

The start times for the subgroup meetings are changed from absolute times to one or more time offset defined relative to the event time (e.g., start time) of the group meeting. The actual event time (e.g., start time, end time, etc.) defined for the group meeting can be controlled by the meeting organizer in real time during the meeting.

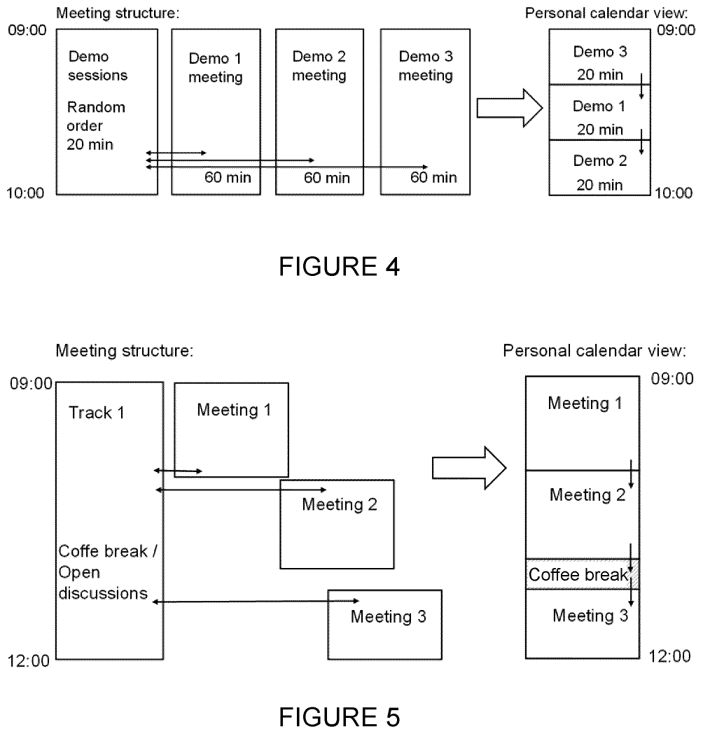

FIG. 4 illustrates a logical operational view of the database where three concurrent demo sessions are running, and every 20 minutes each demo is restarted with a new group of participants, and for each participant the schedule is automatically created to ensure the groups stay small, in accordance with some embodiments of the present disclosure. For each participant the schedule is automatically created to ensure the groups stay small.

FIG. 5 illustrates a logical operational view of the database where a track from a multi-track conference is shown, and the corresponding view for an invited user in accordance with some embodiments of the present disclosure. If a meeting ends early the participants are transferred to the “coffee break” room. When the next meeting starts the participants are automatically transferred to the next meeting, this is illustrated with an arrow between the meetings in the calendar view.

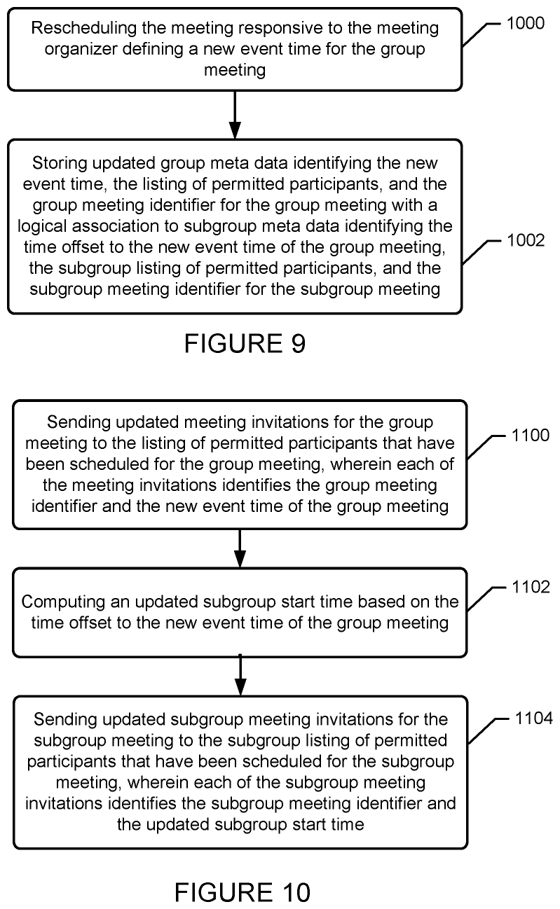

FIG. 9 illustrates a flowchart of further operations by the virtual conference meeting server 100 for rescheduling a meeting in accordance with some embodiments of the present disclosure.

Referring to FIG. 9, the operations include rescheduling 1000 the meeting responsive to the meeting organizer defining a new event time for the group meeting. The operations store 1002 updated group meta data identifying the new event time, the listing of permitted participants, and the group meeting identifier for the group meeting with a logical association to subgroup meta data identifying the time offset to the new event time of the group meeting, the subgroup listing of permitted participants, and the subgroup meeting identifier for the subgroup meeting.

The operations can include handling cancellation of a group meeting which is logically associated with one or more subgroup meetings. In some further embodiments, the operations include deleting the group meta data and subgroup meta data and sending meeting cancelation notifications to the listing of permitted participants and the subgroup listing of permitted participants responsive to the meeting organizer cancelling the group meeting.

An example implementation of some of these embodiments is now explained without limitation.

In this exemplary implementation of these embodiments, the meeting organizer wants to reschedule or cancel all linked meetings. By rescheduling or cancelling the group meeting, all child, subgroup meetings will also be rescheduled or cancelled automatically in the database of the virtual conference meeting server 100. A user can manipulate a GUI, such as illustrated in FIGS. 2 and 3, by selecting and moving the group meeting object to also cause the subgroup meetings to move accordingly, when the start time of the subgroup meetings is set as an offset to the group meeting. When a subgroup meeting has been linked to/from multiple group meetings (“parents”), user input will be needed before that meeting can be rescheduled or cancelled by one of its “parents”.

FIG. 10 illustrates a flowchart of further operations by the virtual conference meeting server 100 to invite participant devices to a meeting in accordance with some embodiments of the present disclosure.

Referring to FIG. 10, the operations include sending 1100 updated meeting invitations for the group meeting to the listing of permitted participants that have been scheduled for the group meeting, where each of the meeting invitations identifies the group meeting identifier and the new event time of the group meeting. The operations also include computing 1102 an updated subgroup start time based on the time offset to the new event time of the group meeting. The operations also include sending 1104 updated subgroup meeting invitations for the subgroup meeting to the subgroup listing of permitted participants that have been scheduled for the subgroup meeting, where each of the subgroup meeting invitations identifies the subgroup meeting identifier and the updated subgroup start time.

In an exemplary implementation of this embodiment, the meeting organizer wants to invite participants to meetings. The list of invited participants in the group meeting (or a sub-set thereof) can be inherited by the subgroup meetings or vice versa, i.e., new participants invited to the subgroup meetings can automatically be invited to the group meeting.

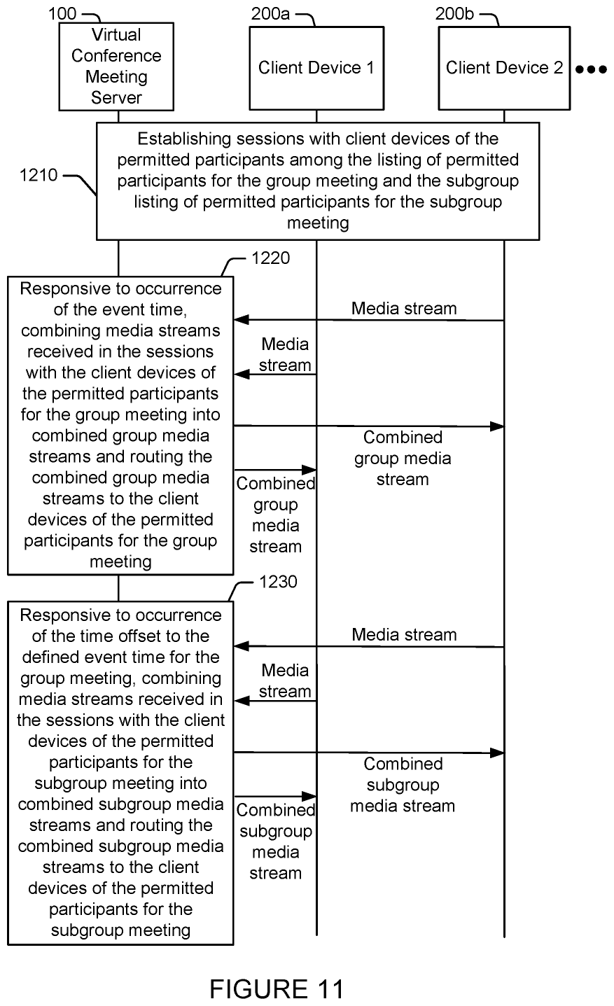

FIG. 11 illustrates a flowchart of further operations by the virtual conference meeting server 100 to start scheduled meetings with client device_1 200a and client device_2 200b in accordance with some embodiments of the present disclosure.

Referring to FIG. 11, the operations include establishing 1210 sessions with client devices 200a and 200b of the permitted participants among the listing of permitted participants for the group meeting and the subgroup listing of permitted participants for the subgroup meeting. The operations also include, responsive to occurrence of the event time, combining 1220 media streams received in the sessions with the client devices of the permitted participants for the group meeting into combined group media streams and routing the combined group media streams to the client devices of the permitted participants for the group meeting. The operations also include, responsive to occurrence of the time offset to the start of the group meeting, combining 1230 media streams received in the sessions with the client devices of the permitted participants for the subgroup meeting into combined subgroup media streams and routing the combined subgroup media streams to the client devices of the permitted participants for the subgroup meeting.

For example, these embodiments may be implemented as now explained.

The meeting organizer wants to start scheduled (concurrent) subgroup meetings. The meeting organizer, who is participating in the group meeting, starts the subgroup meetings. The virtual conference meeting server 100 will be updated with new details for these meetings such as status and event time. The conference client/server, such as the virtual conference meeting server 100, will start the process of transferring participants to subgroup meetings unless they disagree. If a participant is invited to several parallel meetings, the participant input is required before the right subgroup meeting can be joined.

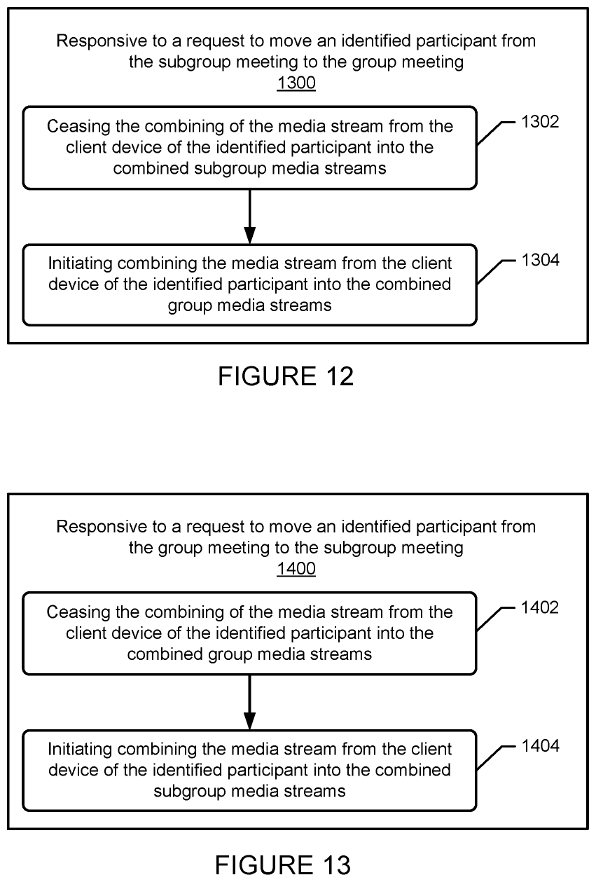

FIG. 12 illustrates a flowchart of further operations by the virtual conference meeting server 100 to end participation in a subgroup meeting and join a group meeting in accordance with some embodiments of the present disclosure.

Referring to FIG. 12, the operations include responding 1300 to a request to move an identified participant from the subgroup meeting to the group meeting, by ceasing 1302 the combining of the media stream from the client device of the identified participant into the combined subgroup media streams. Also, responsive 1300 to the request to move an identified participant from the subgroup meeting to the group meeting, the operations initiate 1304 combining of the media stream from the client device of the identified participant into the combined group media streams.

FIG. 13 illustrates a flowchart of further operations by the virtual conference meeting server 100 to end participation in a group meeting and join a subgroup meeting in accordance with some embodiments of the present disclosure.

Referring to FIG. 13, the operations include, responsive 1400 to a request to move an identified participant from the group meeting to the subgroup meeting, ceasing 1402 the combining of the media stream from the client device of the identified participant into the combined group media streams. Also, responsive 1400 to the request to move an identified participant from the group meeting to the subgroup meeting, initiating 1404 combining the media stream from the client device of the identified participant into the combined subgroup media streams.

For example, these embodiments may be implemented as now explained.

A participant in a subgroup meeting wants to end the subgroup meeting and re-join the group meeting. Meeting participant selects “re-join group meeting.” There could be meeting structures where a subgroup meeting has multiple parents, and a specific user is invited to both parent meetings. In that case the virtual conference meeting server 100 needs to store which meeting the user was participating in before being transferred or ask for user input.

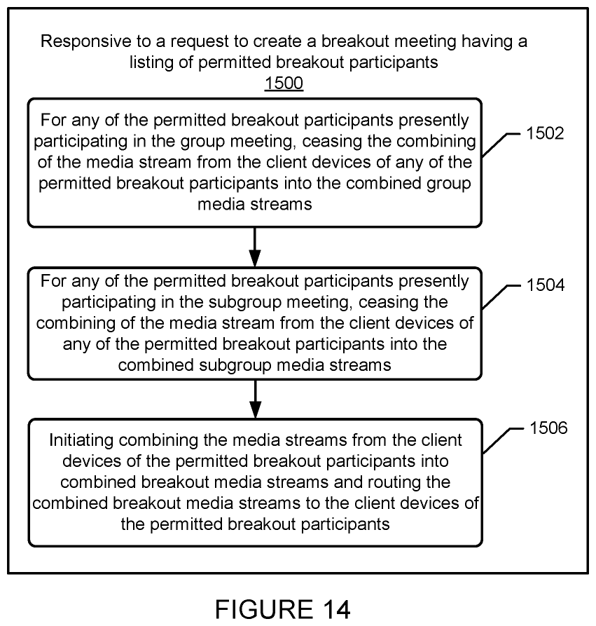

FIG. 14 illustrates a flowchart of further operations by the virtual conference meeting server 100 to create a breakout meeting or two-way announcement with participants in accordance with some embodiments of the present disclosure.

Referring to FIG. 14, the operations include, responsive 1500 to a request to create a breakout meeting having a listing of permitted breakout participants, for any of the permitted breakout participants presently participating in the group meeting, ceasing 1502 the combining of the media stream from the client devices of any of the permitted breakout participants into the combined group media streams. Also, responsive 1500 to the request to create a breakout meeting having a listing of permitted breakout participants, for any of the permitted breakout participants presently participating in the subgroup meeting, ceasing 1504 the combining of the media stream from the client devices of any of the permitted breakout participants into the combined subgroup media streams. Also, responsive 1500 to the request to create a breakout meeting having a listing of permitted breakout participants, initiating 1506 combining the media streams from the client devices of the permitted breakout participants into combined breakout media streams and routing the combined breakout media streams to the client devices of the permitted breakout participants.

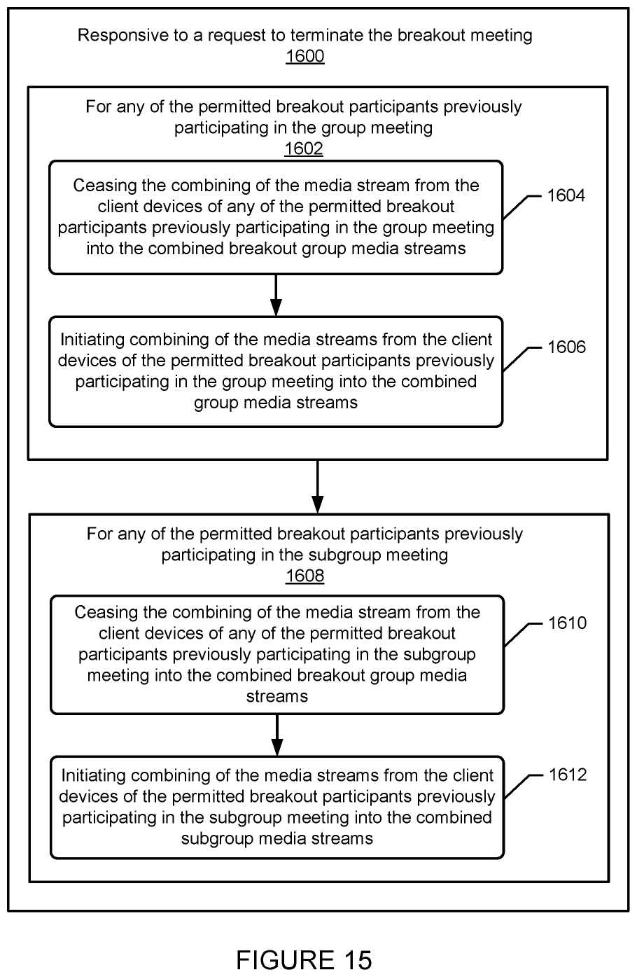

FIG. 15 illustrates a flowchart of further operations by the virtual conference meeting server 100 to terminate a breakout meeting or two-way announcement with participants in accordance with some embodiments of the present disclosure.

Referring to FIG. 15, the operations include, responsive 1600 to a request to terminate the breakout meeting, and for 1602 any of the permitted breakout participants previously participating in the group meeting, ceasing 1604 the combining of the media stream from the client devices of any of the permitted breakout participants previously participating in the group meeting into the combined breakout group media streams. Also, responsive 1600 to the request to terminate the breakout meeting, and for 1602 any of the permitted breakout participants previously participating in the group meeting, initiating 1606 combining of the media streams from the client devices of the permitted breakout participants previously participating in the group meeting into the combined group media streams.

The operations also further include, responsive 1600 to a request to terminate the breakout meeting, and for 1608 any of the permitted breakout participants previously participating in the subgroup meeting, ceasing 1610 the combining of the media stream from the client devices of any of the permitted breakout participants previously participating in the subgroup meeting into the combined breakout group media streams. Also, responsive 1600 to a request to terminate the breakout meeting, and for 1608 any of the permitted breakout participants previously participating in the subgroup meeting, initiating 1612 combining of the media streams from the client devices of the permitted breakout participants previously participating in the subgroup meeting into the combined subgroup media streams.

For example, these embodiments may be implemented as now explained.

The meeting organizer wants to make a breakout meeting, also called a two-way announcement, (i.e., have a dialog) with participants from the ongoing subgroup meetings. The meeting organizer, who is now participating in the group meeting, interfaces with the virtual conference meeting server 100 to request to start a two-way announcement. The meeting organizer chooses to include participants from all subgroup meetings, or from a subset of the subgroup meetings. The meeting organizer may define more than one breakout meeting, such as a first breakout meeting for a subset of the group meeting participants and a second breakout meeting for another subset of the group meeting participants. The meeting organizer can use more conditions, such as only include users that are invited to the group meeting. The meeting organizer can perform one-way or two-way communications with participants of the one or more breakout meetings. In one use example, the group meeting is split into two smaller subgroups for brainstorming: a first team, and a second team. Based on the first team finishing their discussion earlier than the second team, the meeting organizer responsively send an announcement “you can take a break and let's gather together 10 minutes later” to participants of the first team. However, because the second team has not completed discussions, the meeting organizer can send another notification such as “make your presentation ready in 10 minutes” to participants of the second team. Then the second team can respond back “we need 20 minutes more” to the meeting organizer via a two-way announcement pathway. The meeting organizer can responsively send a notification to the first team again saying, “let's meet at the group level in 20 minutes.”

The virtual conference meeting server 100 may freeze audio/video for targeted participants. The virtual conference meeting server 100 notifies the user that a breakout meeting, also known as a two-way announcement, is starting. If some participants are not part of a breakout meeting, the client may use e.g., a symbol to illustrate that some persons are not available. The meeting server saves (for all targeted participants) a reference to which meeting they are currently attending. Targeted participants are temporarily moved to the group meeting. During the announcement, a dialog among all participants in the group meeting is possible. A breakout meeting can contain any content that a regular meeting can such as audio/video/chat/screen sharing. When the meeting organizer ends the breakout meeting, the meeting client for all participants are contacted by the conference server and show a notification that the breakout meeting is over. All participants will automatically re-join their respective subgroup meetings.

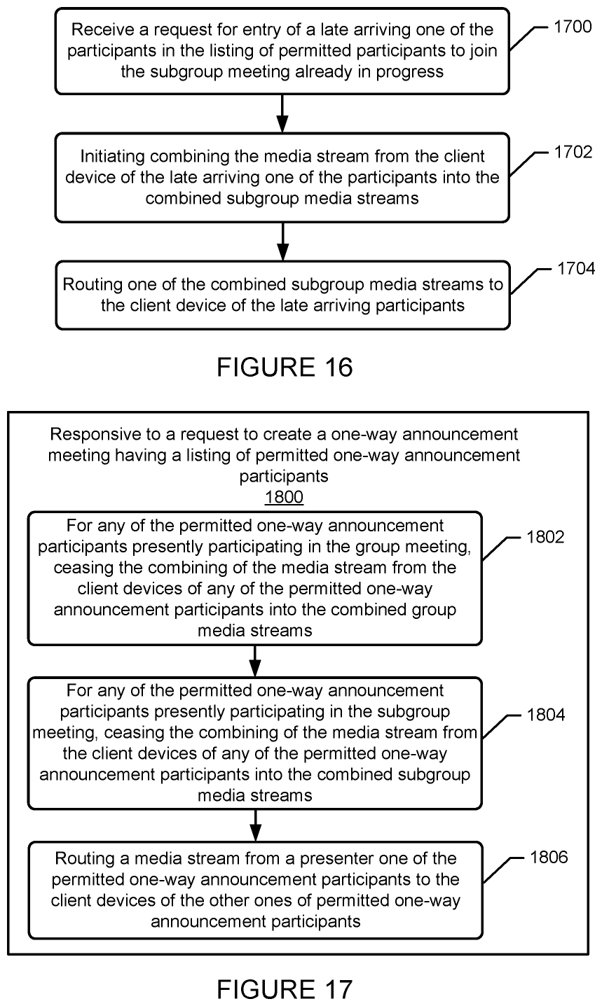

FIG. 16 illustrates a flowchart of further operations by the virtual conference meeting server 100 to redirect a late joining participant to the appropriate meeting in accordance with some embodiments of the present disclosure.

Referring to FIG. 16, the operations include receiving 1700 a request for entry of a late arriving one of the participants in the listing of permitted participants to join the subgroup meeting already in progress. The operations also include initiating 1702 combining the media stream from the client device of the late arriving one of the participants into the combined subgroup media streams. The operations also include routing 1704 one of the combined subgroup media streams to the client device of the late arriving participants.

For example, these embodiments may be implemented as now explained.

A late participant joins the group meeting after the subgroup meetings have started and participants have already been transferred. The meeting client will automatically transfer the user to the ongoing subgroup meeting, unless the user disagrees. The late joining participant may be directly joined to the appropriate subgroup meeting, or the late joining participant may join the ended group meeting and then be transferred to the appropriate subgroup meeting.

FIG. 17 illustrates a flowchart of further operations by the virtual conference meeting server 100 to create a one-way announcement, also called an announcement meeting, in accordance with some embodiments of the present disclosure.

Referring to FIG. 17 the operations further include, responsive 1800 to a request to create a one-way announcement meeting having a listing of permitted one-way announcement participants, ceasing 1802 the combining of the media stream from the client devices of any of the permitted one-way announcement participants into the combined group media streams for any of the permitted one-way announcement participants presently participating in the group meeting. Also, responsive 1800 to the request to create a one-way announcement meeting having a listing of permitted one-way announcement participants, the operations cease 1804 the combining of the media stream from the client devices of any of the permitted one-way announcement participants into the combined subgroup media streams for any of the permitted one-way announcement participants presently participating in the subgroup meeting. Also, responsive 1800 to the request to create a one-way announcement meeting having a listing of permitted one-way announcement participants, the operations route 1806 a media stream from a presenter one of the permitted one-way announcement participants to the client devices of the other ones of permitted one-way announcement participants.

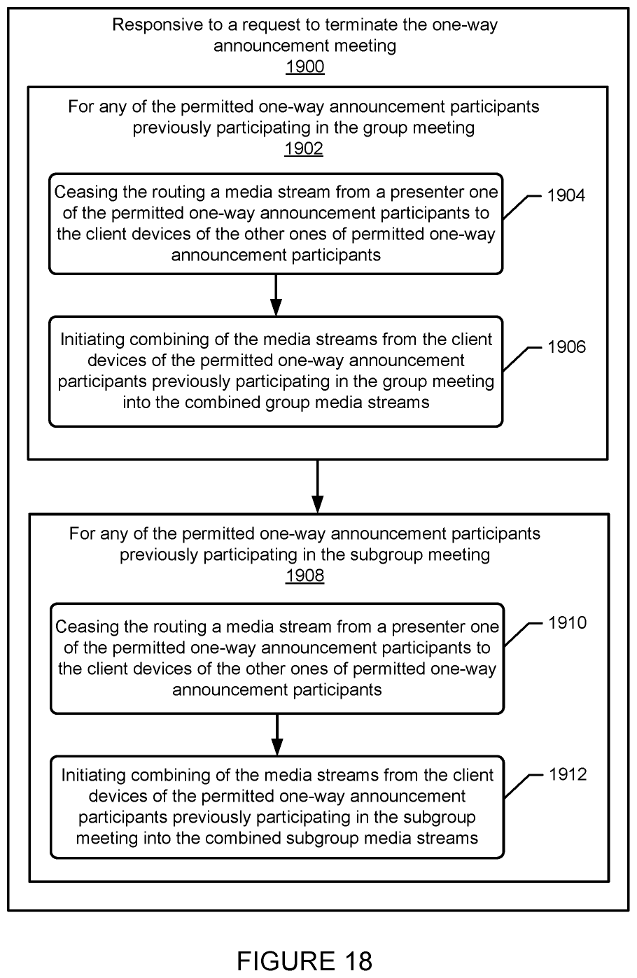

FIG. 18 illustrates a flowchart of further operations by the virtual conference meeting server 100 to terminate a one-way announcement, also called an announcement meeting, in accordance with some embodiments of the present disclosure.

Referring to FIG. 18, the operations include responsive 1900 to a request to terminate the one-way announcement meeting and for 1902 any of the permitted one-way announcement participants previously participating in the group meeting, ceasing 1904 the routing a media stream from a presenter one of the permitted one-way announcement participants to the client devices of the other ones of permitted one-way announcement participants. Also, responsive 1900 to a request to terminate the one-way announcement meeting and for 1902 any of the permitted one-way announcement participants previously participating in the group meeting, the operations initiate 1906 combining of the media streams from the client devices of the permitted one-way announcement participants previously participating in the group meeting into the combined group media streams.

The operations also include, responsive 1900 to a request to terminate the one-way announcement meeting and for 1908 any of the permitted one-way announcement participants previously participating in the subgroup meeting, ceasing 1910 the routing a media stream from a presenter one of the permitted one-way announcement participants to the client devices of the other ones of permitted one-way announcement participants. Also, responsive 1900 to the request to terminate the one-way announcement meeting and for 1908 any of the permitted one-way announcement participants previously participating in the subgroup meeting, the operations initiate 1912 combining of the media streams from the client devices of the permitted one-way announcement participants previously participating in the subgroup meeting into the combined subgroup media streams.

For example, these embodiments may be implemented as now explained.

The meeting organizer wants to make an announcement to the participants in the subgroup meetings by starting a one-way announcement meeting. The meeting organizer, which is now participating in the group meeting, contacts the virtual conference meeting server 100 and request to start an announcement in subgroup meetings. The organizer selects which of the subgroup meetings that should be receiving the announcement. The audio/video will be played in the subgroup meetings.

In some further examples of the implementation of various embodiments, meetings with relationships could be highlighted with visual effects in a calendar. For example, by using the same color for group meeting and linked meetings or show them as sub-meetings “inside” a group meeting if there is a common parent meeting.

In another embodiment, the relationship between meetings can be created according to time order, for example subsequent meetings. If the first meeting must end before the second can start. An example is if a decision operation has to be made in the first meeting, before the next meeting can start. Another example is if a key person is supposed to be part of both meetings. Creating relationships between scheduled meetings thereby makes it clear for the participants that if meeting one is running late, an associated other meeting will be delayed accordingly.

### Further Definitions and Embodiments

In the above description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.,”, which derives from the Latin phrase “exempli gratia,” may be used to introduce or specify a general example or examples of a previously mentioned item, and is not intended to be limiting of such item. The common abbreviation “i.e.,”, which derives from the Latin phrase “id Est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the appended examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the following examples of embodiments and their equivalents, and shall not be restricted or limited by the foregoing detailed description.

1. A virtual conference meeting server comprising:
at least one processor; and
at least one memory storing program code executable by at least one processor to perform operations comprising:
schedule a plurality of meetings responsive to input from a meeting organizer,
wherein one of the plurality of meetings is a group meeting having an event time, a listing of permitted participants, and a group meeting identifier, and
another one of the plurality of meetings is a subgroup meeting having a start time defined as a time offset to the event time of the group meeting, a subgroup listing of permitted participants, and a subgroup meeting identifier; and
store group meta data identifying the event time, the listing of permitted participants, and the group meeting identifier for the group meeting with a logical association to subgroup meta data identifying the time offset to the event time of the group meeting, the subgroup listing of permitted participants, and the subgroup meeting identifier for the subgroup meeting.

2. The virtual conference meeting server of claim 1, wherein the operations further comprise:
send meeting invitations for the group meeting to the listing of permitted participants that have been scheduled for the group meeting, wherein each of the meeting invitations identifies the group meeting identifier and the event time of the group meeting.
compute a subgroup start time based on the time offset to the event time of the group meeting; and
send subgroup meeting invitations for the subgroup meeting to the subgroup listing of permitted participants that have been scheduled for the subgroup meeting, wherein each of the subgroup meeting invitations identifies the subgroup meeting identifier and the subgroup start time.

3. The virtual conference meeting server claim 1, wherein the operations further comprise:
reschedule the meeting responsive to the meeting organizer defining a new event time for the group meeting, and
store updated group meta data identifying the new event time, the listing of permitted participants, and the group meeting identifier for the group meeting with a logical association to subgroup meta data identifying the time offset to the new event time of the group meeting, the subgroup listing of permitted participants, and the subgroup meeting identifier for the subgroup meeting.

4. The virtual conference meeting server of claim 3, wherein the operations further comprise:
send updated meeting invitations for the group meeting to the listing of permitted participants that have been scheduled for the group meeting, wherein each of the meeting invitations identifies the group meeting identifier and the new event time of the group meeting;
compute an updated subgroup start time based on the time offset to the new event time of the group meeting; and
send updated subgroup meeting invitations for the subgroup meeting to the subgroup listing of permitted participants that have been scheduled for the subgroup meeting, wherein each of the subgroup meeting invitations identifies the subgroup meeting identifier and the updated subgroup start time.

5. The virtual conference meeting server of claim 1, wherein the operations further comprise:
responsive to the meeting organizer cancelling the group meeting, delete the group meta data and subgroup meta data, and send meeting cancelation notifications to the listing of permitted participants and the subgroup listing of permitted participants.

6. The virtual conference meeting server of claim 1, wherein the operations further comprise:
establish sessions with client devices of the permitted participants among the listing of permitted participants for the group meeting and the subgroup listing of permitted participants for the subgroup meeting;
responsive to occurrence of the event time, combine media streams received in the sessions with the client devices of the permitted participants for the group meeting into combined group media streams and route the combined group media streams to the client devices of the permitted participants for the group meeting; and
responsive to occurrence of the time offset to the event time of the group meeting, combine media streams received in the sessions with the client devices of the permitted participants for the subgroup meeting into combined subgroup media streams and route the combined subgroup media streams to the client devices of the permitted participants for the subgroup meeting.

7. The virtual conference meeting server of claim 6, wherein the operations further comprise:
responsive to a request to move an identified participant from the subgroup meeting to the group meeting,
cease the combining of the media stream from the client device of the identified participant into the combined subgroup media streams; and
initiate combining the media stream from the client device of the identified participant into the combined group media streams.

8. The virtual conference meeting server of claim 6, wherein the operations further comprise:
responsive to a request to move an identified participant from the group meeting to the subgroup meeting,
cease the combining of the media stream from the client device of the identified participant into the combined group media streams; and
initiate combining the media stream from the client device of the identified participant into the combined subgroup media streams.

9. The virtual conference meeting server of claim 6, wherein the operations further comprise:
responsive to a request to create a breakout meeting having a listing of permitted breakout participants,
for any of the permitted breakout participants presently participating in the group meeting, cease the combining of the media stream from the client devices of any of the permitted breakout participants into the combined group media streams;
for any of the permitted breakout participants presently participating in the subgroup meeting, cease the combining of the media stream from the client devices of any of the permitted breakout participants into the combined subgroup media streams; and
initiate combining the media streams from the client devices of the permitted breakout participants into combined breakout media streams and routing the combined breakout media streams to the client devices of the permitted breakout participants.

10. The virtual conference meeting server of claim 9, wherein the operations further comprise:
responsive to a request to terminate the breakout meeting,
for any of the permitted breakout participants previously participating in the group meeting,
cease the combining of the media stream from the client devices of any of the permitted breakout participants previously participating in the group meeting into the combined breakout group media streams, and
initiate combining of the media streams from the client devices of the permitted breakout participants previously participating in the group meeting into the combined group media streams; and
for any of the permitted breakout participants previously participating in the subgroup meeting,
cease the combining of the media stream from the client devices of any of the permitted breakout participants previously participating in the subgroup meeting into the combined breakout group media streams, and
initiate combining of the media streams from the client devices of the permitted breakout participants previously participating in the subgroup meeting into the combined subgroup media streams.

11.-13. (canceled)

14. A method by a virtual conference meeting server for a plurality of meetings, the method comprising:
scheduling the plurality of meetings responsive to input from a meeting organizer,
wherein one of the plurality of meetings is a group meeting having an event time, a listing of permitted participants, and a group meeting identifier, and
another one of the plurality of meetings is a subgroup meeting having a start time defined as a time offset to the event time of the group meeting, a subgroup listing of permitted participants, and a subgroup meeting identifier; and
storing group meta data identifying the event time, the listing of permitted participants, and the group meeting identifier for the group meeting with a logical association to subgroup meta data identifying the time offset to the event time of the group meeting, the subgroup listing of permitted participants, and the subgroup meeting identifier for the subgroup meeting.

15. The method of claim 14, further comprising:
sending meeting invitations for the group meeting to the listing of permitted participants that have been scheduled for the group meeting, wherein each of the meeting invitations identifies the group meeting identifier and the event time of the group meeting;
computing a subgroup start time based on the time offset to the event time of the group meeting; and
sending subgroup meeting invitations for the subgroup meeting to the subgroup listing of permitted participants that have been scheduled for the subgroup meeting, wherein each of the subgroup meeting invitations identifies the subgroup meeting identifier and the subgroup start time.

16. The method claim 14, further comprising:
rescheduling the meeting responsive to the meeting organizer defining a new event time for the group meeting, and
storing updated group meta data identifying the new event time, the listing of permitted participants, and the group meeting identifier for the group meeting with a logical association to subgroup meta data identifying the time offset to the new event time of the group meeting, the subgroup listing of permitted participants, and the subgroup meeting identifier for the subgroup meeting.

17. The method of claim 16, further comprising:
sending updated meeting invitations for the group meeting to the listing of permitted participants that have been scheduled for the group meeting, wherein each of the meeting invitations identifies the group meeting identifier and the new event time of the group meeting;
computing an updated subgroup start time based on the time offset to the new event time of the group meeting; and
sending updated subgroup meeting invitations for the subgroup meeting to the subgroup listing of permitted participants that have been scheduled for the subgroup meeting, wherein each of the subgroup meeting invitations identifies the subgroup meeting identifier and the updated subgroup start time.

18. The method of claim 14, further comprising:
responsive to the meeting organizer cancelling the group meeting, deleting the group meta data and subgroup meta data, and send meeting cancelation notifications to the listing of permitted participants and the subgroup listing of permitted participants.

19. The method of claim 14, further comprising:
establishing sessions with client devices of the permitted participants among the listing of permitted participants for the group meeting and the subgroup listing of permitted participants for the subgroup meeting;
responsive to occurrence of the event time, combining media streams received in the sessions with the client devices of the permitted participants for the group meeting into combined group media streams and routing the combined group media streams to the client devices of the permitted participants for the group meeting; and
responsive to occurrence of the time offset to the event time of the group meeting, combining media streams received in the sessions with the client devices of the permitted participants for the subgroup meeting into combined subgroup media streams and routing the combined subgroup media streams to the client devices of the permitted participants for the subgroup meeting.

20. The method of claim 19, further comprising:
responsive to a request to move an identified participant from the subgroup meeting to the group meeting,
ceasing the combining of the media stream from the client device of the identified participant into the combined subgroup media streams; and
initiating combining the media stream from the client device of the identified participant into the combined group media streams.

21. The method of claim 19, further comprising:
responsive to a request to move an identified participant from the group meeting to the subgroup meeting,
ceasing the combining of the media stream from the client device of the identified participant into the combined group media streams; and
initiating combining the media stream from the client device of the identified participant into the combined subgroup media streams.

22. The method of claim 19, further comprising:
responsive to a request to create a breakout meeting having a listing of permitted breakout participants,
for any of the permitted breakout participants presently participating in the group meeting, ceasing the combining of the media stream from the client devices of any of the permitted breakout participants into the combined group media streams;
for any of the permitted breakout participants presently participating in the subgroup meeting, ceasing the combining of the media stream from the client devices of any of the permitted breakout participants into the combined subgroup media streams; and
initiating combining the media streams from the client devices of the permitted breakout participants into combined breakout media streams and routing the combined breakout media streams to the client devices of the permitted breakout participants.

23. The method of claim 22, further comprising:
responsive to a request to terminate the breakout meeting,
for any of the permitted breakout participants previously participating in the group meeting,
ceasing the combining of the media stream from the client devices of any of the permitted breakout participants previously participating in the group meeting into the combined breakout group media streams, and
initiating combining of the media streams from the client devices of the permitted breakout participants previously participating in the group meeting into the combined group media streams; and
for any of the permitted breakout participants previously participating in the subgroup meeting,
ceasing the combining of the media stream from the client devices of any of the permitted breakout participants previously participating in the subgroup meeting into the combined breakout group media streams, and
initiating combining of the media streams from the client devices of the permitted breakout participants previously participating in the subgroup meeting into the combined subgroup media streams.

24.-26. (canceled)
